(19) United States
(12) Patent Application Publication
(10) Pub. No.: US 2013/0252116 A1
(43) Pub. Date: Sep. 26, 2013

(54) Model Based Approach For In-Situ WVTD Degradation Detection In Fuel Cell Vehicles

(71) Applicants: Yan Zhang, Victor, NY (US); Manish Sinha, Pittsford, NY (US); Loren Devries, Ionia, NY (US)

(72) Inventors: Yan Zhang, Victor, NY (US); Manish Sinha, Pittsford, NY (US); Loren Devries, Ionia, NY (US)

(73) Assignee: GM GLOBAL TECHNOLOGY OPERATIONS LLC, Detroit, MI (US)

(21) Appl. No.: 13/425,598

(22) Filed: Mar. 21, 2012

(51) Int. Cl. H01M 8/04; G06F 19/00; G01N 19/10

(52) U.S. Cl. 429/413; 429/450; 73/29.02; 702/24

(57) ABSTRACT

A method of estimating water vapor transfer unit degradation without having to remove the unit from a fuel cell system to which it cooperates, and a device performing the same. The method includes using a combination of a backward-looking model and a forward-looking model. The first of these models is used to evaluate changes in water vapor transfer effectiveness in the unit, while the second is for determining the water transfer rate of the unit. Together, the models provide a more accurate way to estimate and control relative humidity for both stack inlet and outlet flowpaths, as well as provide an indication of when service or replacement of the water vapor transfer unit may be warranted.

### BACKGROUND OF THE INVENTION

The present invention relates generally to monitoring a water vapor transfer (WVT) device used in a fuel cell system, and more particularly to using one or more hydration models to permit in-situ monitoring and evaluation of performance characteristics of the WVT device.

Fuel cells, particularly proton exchange membrane or polymer electrolyte membrane (in either event, PEM) fuel cells, require balanced water levels to ensure proper operation. For example, it is important to avoid having too much water in the fuel cell, which can result in the flooding or related blockage of the reactant flowfield channels. On the other hand, too little hydration limits the conductivity of the ion-transmissive membrane that is disposed between catalyzed electrodes; this high ionic resistance can lead to poor electrical performance, as well as premature cell failure. One popular way to promote proper levels of humidification or related water balance within the fuel cell is through one or more WVT units or devices (also referred to as a cathode humidifier unit, membrane humidifier, fuel cell humidifier or the like). In a typical WVT unit configuration, wet-side and dry-side reactant flowpaths (for example, a cathode exhaust and a cathode inlet) are in moisture-exchange communication with one another through a membrane media in the WVT unit such that excess moisture leaving the cathode exhaust may diffuse through the media to the drier flowpath on the cathode inlet. Examples of WVT units may be found in U.S. Pat. Nos. 7,749,661, 7,875,396 and 8,048,585, all of which are assigned to the assignee of the present invention and the entire contents of which are herein incorporated fully by reference.

In situations where numerous fuel cells are arranged as part of a module, stack or related larger assembly of fuel cell system components, a good measure of an overall humidification level for the various cell membranes can be derived from a relative humidity sensor placed in the cathode inlet gas stream. This measurement is used in conjunction with other factors, for example, cathode inlet air flowrate, cathode inlet temperature and cathode inlet pressure, to estimate the water transfer rate (WTR) of the WVT unit as one indicia of its performance.

There are other ways of acquiring humidity information besides using the aforementioned sensors. One way takes advantage of a fuel cell's inherent high frequency resistance (HFR), which is a directly-measurable property related to the ability of protons to pass through the cell's ion-transmissive membrane; this mobility is in turn is a function of the level of humidification of the cell. One approach to using HFR as a way to estimate and control cathode inlet and outlet flow humidities may be found in U.S. application Ser. No. 12/622,212, filed on Nov. 19, 2009 and entitled Online Estimation of Cathode Inlet and Outlet RH from Stack Average HFR, which is owned by the Assignee of the present application and incorporated herein by reference.

While determining an HFR between stack terminals may provide a good measure of average stack membrane relative humidity for helping to meet stack efficiency targets, it is not sufficient for identifying issues related to WVT unit degradation or wear. The conventional way of characterizing WVT unit degradation is to perform off-line testing of the unit while on a component test stand. This necessitates removing the WVT unit from the fuel cell system, testing it on the component test stand and reinstalling the unit back in the system; such an approach requires a lot of WVT unit downtime (for example, about 48 hours). Consequently, performing frequent off-line testing of fuel cell systems—such as those contemplated for vehicular applications—as a way to determine unit degradation is not practical.

### SUMMARY OF THE INVENTION

According to one aspect of the invention, a method of in-situ WVT unit degradation detection or estimation includes using a combination of a backward-looking (i.e., reverse) model and a forward-looking model. In the present context, in-situ activities are those that are conducted without requiring the WVT unit to be removed from the fuel cell stack or system with which it is operative; as such, measurements and related determinations or predictions may be made while the fuel cell stack or system is operative, or at least without having to remove or otherwise decouple the WVT unit from the remainder of the fuel cell system. Using such models (the first for the unit itself and the second for stack HFR and hydration) as a basis for stack water management is a more accurate way to estimate and control relative humidity for both stack inlet and outlet conditions than through a mere averaging technique. For example, a loss in WVT unit effectiveness at any given vehicle operating condition or time (including, for example, historical operational data) generated by the first model based on WTR feedback coupled with operating condition information can be input into the second model which includes an algorithm to estimate both inlet and outlet relative humidity values of the stack; in one form, the second model may use expected maximum power operations conditions of the fuel cell stack, including temperatures, pressures and flows. Such estimation may form the basis for online control of the fuel cell system, as well as provide indicia of when WVT device service may be warranted. The use of the two models working in conjunction with one another helps compensate for situations where sensed values are prone to inaccuracies, such as due to sensor failure (for example, a humidity sensor is prone to failure when being exposed to liquid water).

According to another aspect of the invention, a method of servicing a WVT unit (also referred to as a WVT device) used in a fuel cell system is disclosed. The method includes, in addition to providing in-situ a WVT device water transfer rate and estimating a reduced WVT device effectiveness, estimating the WTR at maximum power conditions at a given vehicle life and comparing the estimated WTR with an initial Beginning of Life (BOL) WTR, and servicing the WVT device when a difference in the values determined by the compared estimations exceeds a predetermined threshold.

According to another aspect of the invention, a WVT device for use in a fuel cell system includes one or more dry side flowpaths, one or more wet side flowpaths, a membrane placed relative to the dry and wet side flowpaths such that upon passage of relatively dry and relatively wet fuel cell reactant through the respective flowpaths, an exchange in humidity occurs between the dry and wet reactant streams. The device also includes one or more sensors to measure WTR information, as well as a controller configured to estimate a reduced device effectiveness and estimate a WTR for the device, as well as to estimate a WTR loss in the device.

### BRIEF DESCRIPTION OF THE DRAWINGS

The following detailed description of specific embodiments can be best understood when read in conjunction with the following drawings, where like structure is indicated with like reference numerals and in which:

FIG. 1 is a block diagram of a fuel cell system with a WVT unit;

FIG. 2 is a flow diagram showing in-situ modeling of WVT unit degradation according to an aspect of the present invention;

FIG. 3 is a graph showing the WVT unit degradation in a representative fuel cell module;

FIG. 4 is a graph showing details of the reverse WVT unit model;

FIG. 5 shows a vehicle employing a fuel cell system with a WVT unit degradation-detection approach according to an aspect of the present invention; and

FIG. 6 is a graph showing the typical relationship between MEA hydration X and cathode RH.

### DETAILED DESCRIPTION OF THE PREFERRED EMBODIMENTS

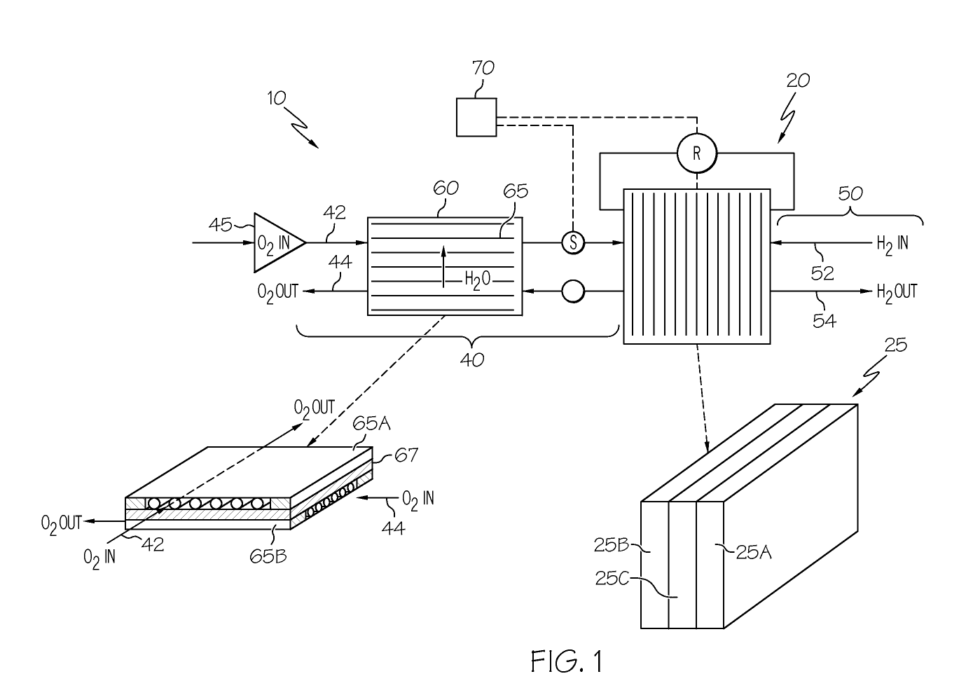

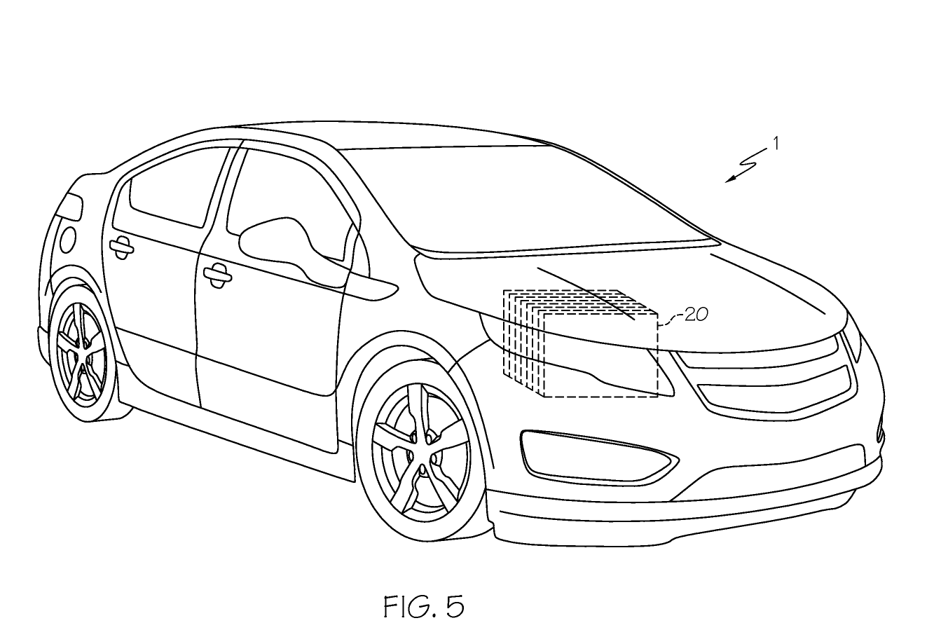

Referring first to FIGS. 1 and 5, a fuel cell system 10 includes a fuel cell stack 20 made up of numerous individual fuel cells 25, each of which has an anode 25A and cathode 25B separated by an ion-transmissive membrane 25C, as well as an automobile 1 being powered by fuel cell stack 20 is shown. As will be understood by those skilled in the art, numerous such cells 25 are combined to form the stack 20 such that the power generation is increased. Likewise, numerous such stacks 20 may be used. Referring with particularity to FIG. 1, various flowpaths 40, 50 are used to convey reactants and their byproducts to and from the stack 20. A WVT unit 60 is fluidly coupled to either or each of the respective flowpaths 40, 50 to promote the balanced humidity levels within one or both of them. As shown with particularity for the cathode-side reactant (i.e., an oxygen-bearing fluid), dry air from a compressor 45 is fed through an inlet flowpath 42 into the WVT unit 60 Likewise, stack cathode exhaust being discharged through an outlet flowpath 44 passes into and through the WVT unit 60. Inside the WVT unit 60 is a core made up of numerous plates 65 (two of which are shown in more detail as dry side plate 65A and wet side plate 65B) that are stacked in an alternating arrangement such that (with the exception of the outermost plates) each plate is sandwiched between plates of the opposing flowpath. A membrane medium 67 is formed between each pair of wet side and dry side plates to allow for selective exchange of humidity between the WVT inlet flowpath 42 and the stack cathode outlet flowpath 44.

A stack humidity sensor S provides in-situ WTR feedback of WVT unit 60. Similarly, a resistor R may be connected across the stack 20. Controller 70 uses values obtained by sensor S and resistor R to measure respectively inlet relative humidity RHᵢₙ of stack 20 and HFR. These measurements may form the basis of the two models discussed above. In particular, at least one of such measurements, in conjunction with water specie balance, can be used to estimate a humidity profile that includes outlet relative humidity RHₒᵤₜ of stack 20. The resistor R may be particularly useful in situations where the sensor S fails to operate correctly, such as due to the presence of liquid water. Such backup measurement is particularly useful because failure circumstances are difficult to diagnose, and often occur during vehicle warm-up and vehicle idle to high power transients. Furthermore, an estimate of RHₒᵤₜ based on water specie balance is very sensitive to temperature and stoichiometry; as such, errors in temperature, air flow or current measurement may limit the ability to provide proper stack humidification control absent a fallback measurement. More particularly, in such situations where the sensor S is not available, the stack HFR measurement from resistor R, which is based on HFR-λ-RH relationships such as described below and in the aforementioned U.S. application Ser. No. 12/622,212, can be used to estimate the in-situ WTR.

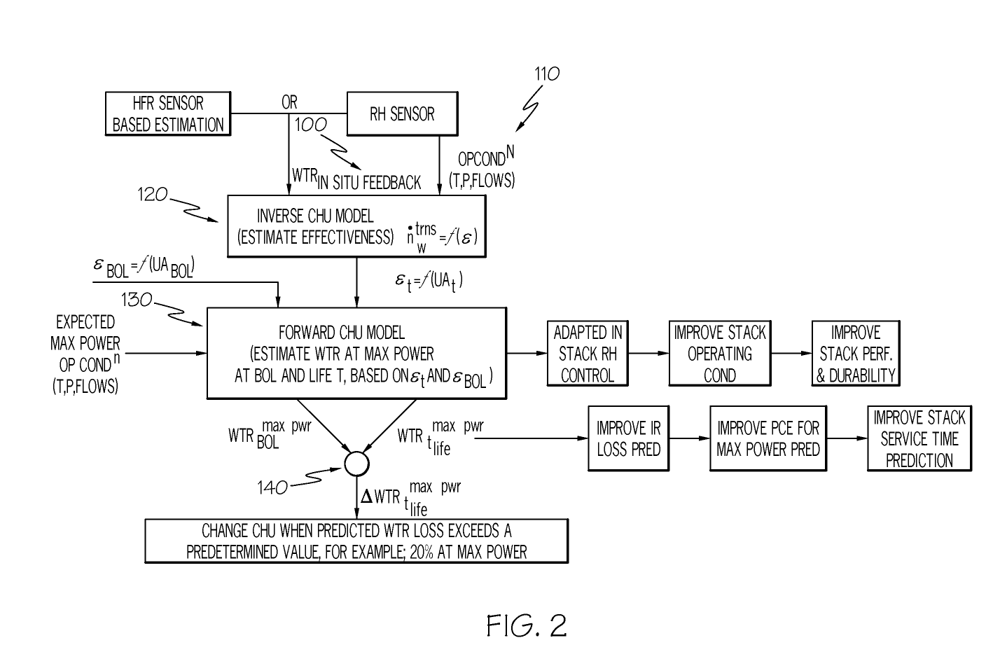

Referring next to FIG. 2, a flow diagram showing the use of the reverse (i.e., inverse) and forward models as a way to predict (among other things) the performance of a WVT unit 60 within fuel cell system 10, such as when unit 60 may be in need of service or replacement, is shown. The acronym CHU shown in the reverse and forward models 120 and 130 stands for cathode humidification unit and is another name of the WVT unit 60; the terms are used interchangeably throughout this disclosure. The in-situ water transfer rate (WTR) feedback 100 of WVT unit 60 that is derived from one of the sensor-based approaches discussed above is used in conjunction with operating condition information 110 (for example, dry inlet and wet inlet stream flow on a dry basis, composition, temperature and pressure) is used as input to a reverse WVT model 120 (also referred to as an effectiveness-based WVT model) to allow the model to provide an on-line estimation of a reduced effectiveness εₜ for the membranes 67 of WVT unit 60 at any vehicle life time. As described below and in U.S. application Ser. No. 12/755,315, filed Apr. 6, 2010 and entitled Using an Effectiveness Approach to Model a Fuel Cell Membrane Humidification Device, which is owned by the Assignee of the present application and incorporated herein by reference, such reduced effectiveness is mostly estimated at low to mid power levels of vehicle or fuel cell system 10 operation, and is based on past (i.e., historical) vehicle or system 10 operating data.

In the present context, the reverse nature of WVT model 120 amounts to estimating a loss in WVT unit effectiveness εₜ based on rearward-looking (i.e., past) vehicular data (mostly at low stack power conditions) in the form of the above operating condition information 110 and in-situ WTR feedback information 100 where the effectiveness εₜ is the ratio of the actual mass transfer rate of humidity to the maximum possible mass transfer rate of humidity that would be realized in a counter-flow mass exchanger having an infinite membrane area. Moreover, this measure of effectiveness εₜ depends on the number of mass transfer units, a non-dimensional ratio of the product (also called product value UA) of the mass transfer coefficient U and membrane area A to the minimum mass flow rate on a dry basis of the dry stream and the wet stream flowing through the dry side and the wet side of the WVT unit 60, respectively. This will be discussed in more detail below. A third non-dimensional parameter employed in the model is a capacity ratio CR, which is the ratio of the minimum mass flow rate on a dry basis of the wet side flow of the outlet flowpath 44 and the dry side flow of the inlet flowpath 42 of the WVT unit 60 to the maximum mass flow rate on a dry basis of the wet side flow of the outlet flowpath 44 and the dry side flow of the inlet flowpath 42 of the WVT unit 60. The capacity ratio CR may be expressed as:

$$CR = \frac{Min ( {M}_{air , dry} , {M}_{wet , air} )}{Max ( {M}_{air , dry} , {M}_{wet , air} )}$$

The reverse WVT model 120 cooperates with controller 70 to adjust the position of one or more valves (not shown) that may be used to control the amount of water provided to the cathode inlet flowpath 42 as a way to control the desired amount of water transfer and related fuel cell humidity in the various membranes 67.

In particular, the calculated reduced effectiveness εₜ taken from the reverse WVT model 120 is next used, along with the expected maximum stack power operating conditions, in the forward WVT model 130 to project the WTR at maximum power at the given vehicle life time WTR^{max}^{_{—}}^{pwr}_{tlife}. The forward WVT model 130 is also used to predict BOL WTR at maximum power with known BOL mass transfer coefficient and membrane area and expected maximum power operating conditions, WTR^{max}^{_{—}}^{pwr}_{BOL}. The BOL mass transfer coefficient and membrane area may be based upon known component design value. The predicted BOL WTR can be stored on computer-readable memory that is part of the controller 70, especially when the controller 70 is configured to include features associated with a traditional Von Neumann (or general-purpose or stored-program) computer that has (among other things) a CPU, input, output and memory, the latter typically in the form of both working (i.e., data-containing or RAM) memory and permanent (i.e., instruction-containing, or ROM, such as system start-up and other features) memory. In one form, the reverse WVT model 120 and the forward WVT model 130 may use the same equations.

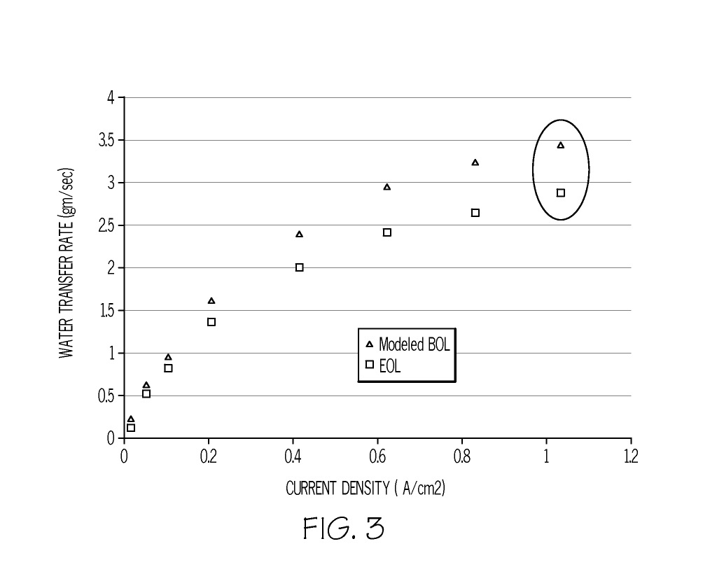

In one preferred form, the reverse WVT model 120 and the forward WVT model 130 may be implemented on-line in the control software that is loaded into controller 70. The difference 140 between the predicted BOL water transfer rate WTR^{max}^{_{—}}^{pwr}_{BOL} and the estimated water transfer rate WTR^{max}^{_{—}}^{pwr}_{tlife} based on the reduced effectiveness derived from the RH sensor S or the HFR sensor R at maximum power yields the degree of WVT on-line degradation ΔWTR_{tlife}^{max}^{_{—}}^{pwr}. Results associated with this method for one particular membrane module is shown in exemplary fashion in FIG. 3, where there was about 17% degradation at 1.0 A/cm² after about 238 hr. Comparable results for two other modules (not shown) showed about 14% degradation after 316 at 1.5 A/cm² and about 15% degradation at 1.5 A/cm² after 120 hr of freeze testing, respectively.

Furthermore, the forward WVT model 130 with the reduced mass transfer coefficients estimated real time can be adapted in the stack RH controls via controller 70 to improve stack operating conditions, resulting in enhanced stack performance and durability. For example, in scenarios where stack operates under greater than 100% cathode outlet RH conditions, HFR response does not have enough resolution for stack RH control, such forward WVT model will be used as a primary tool for stack RH control. Improving the WVT model WTR prediction by including WVT membrane material degradation can result in more accurate stack cathode outlet RH prediction and control, thus enhancing stack performance and durability. When the degree of WVT on-line degradation at maximum power ΔWTR_{tlife}^{max}^{_{pwr}}. exceeds a percentage of the BOL WTR at maximum power WTR^{max}^{_{—}}^{pwr}_{BOL} at any given vehicle life time by a predetermined value (for example 20%), the WVT unit 20 is considered to be at the end of its life and therefore in need of service or replacement in order to regain the desired performance. The model-based approach of the present invention enables the prompt detection of the faster-than-expected WVT degradation rate in WVT unit 60 membranes 67, so proper actions or plans can be put in place to address the degradation issue at earlier stages. The degraded WVT performance can be used to make an informed decision on stack 20 humidification control for stack 20 durability and freeze purge/start-up development. In addition, the projected WTR at maximum power at the given vehicle life time WVT^{max}^{_{—}}^{pwr}_{tlife} can also be utilized to improve the stack voltage/power prediction at maximum power by improving ohmic (i.e., IR) loss estimation, thus better projecting stack service time. For example, the stack voltage IR loss is a function of stack inlet and outlet RHs. Including WVT membrane performance degradation enables more accurate stack inlet and outlet RH estimation, thus improving stack IR loss and voltage prediction.

For certain operating conditions for a given design of WVT unit 60, the amount of water transferred can be estimated using the relationships between the number of mass transfer units, the effectiveness, and the mass flow rates of streams established for heat exchanger designs. The well-established relationships between the heat transfer effectiveness and the number of heat transfer units for heat exchanger designs is available for use based on the analogy between heat transfer and mass transfer, as would be readily apparent to those skilled in the art.

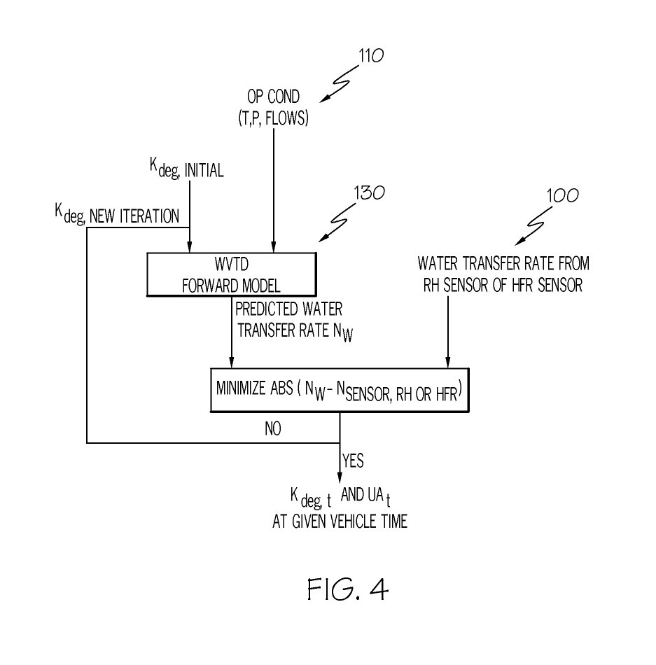

As discussed with more particularity in the aforementioned U.S. application Ser. No. 12/755,315, the water vapor transfer performance of the WVT unit 60 is modeled using Equations (3) through (8) therein (which form the basis for dependent original claims 5 through 10 of the present application). Referring with particularity to FIG. 4, an algorithm depicting how a reverse WVT model 120 is shown. At any given vehicle time, an initial guess of degradation factor K_{deg,initial} between 0 and 1 is provided. From these equations, the amount of water transferred N_{w} in gm water/sec can be predicted based on this initial guess.

In the reverse WVT model 120, the degradation factor K_{deg,t} at any given vehicle life can be obtained by minimizing the difference between the predicted water transfer rate Nw and the measured water transfer rate from a RH sensor based on the past vehicle data. If the WVT water transfer rate from RH sensor (denoted as N_{sensor,RH}) is not available as an input for the reversed WVT model 120, the stack HFR measurement (such as depicted in FIG. 2) can be used to estimate the in-situ water transfer rate based on the aforementioned HFR-λ-RH. In the present case, FIG. 2 is the flow chart which illustrates the model based WVT degradation determination, while FIG. 4 is the flow chart to illustrate how the reverse WVT model works. As such, FIG. 4 is a subset of FIG. 2. The estimate can be made as follows.

HFR based estimation of internal humidification of stack 20 offers a “stack-as-sensor” approach that directly measures the internal state of MEA hydration. HFR is a strong function of MEA hydration λ and a weak function of temperature T, where the equations 1 and 2 below illustrate such relationships:

$$σ = exp [ 1268 ( \frac{1}{303} - \frac{1}{273 + T} ) ] \cdot [ 0.005139 λ - 0.00326 ] \\ {( ohm - cm )}^{- 1} \qquad ( 1 )$$

HFR resistance R is calculated as:

$$R = \frac{membrane\_thickness}{σ} ( ohm - {cm}^{2} ) \qquad ( 2 )$$

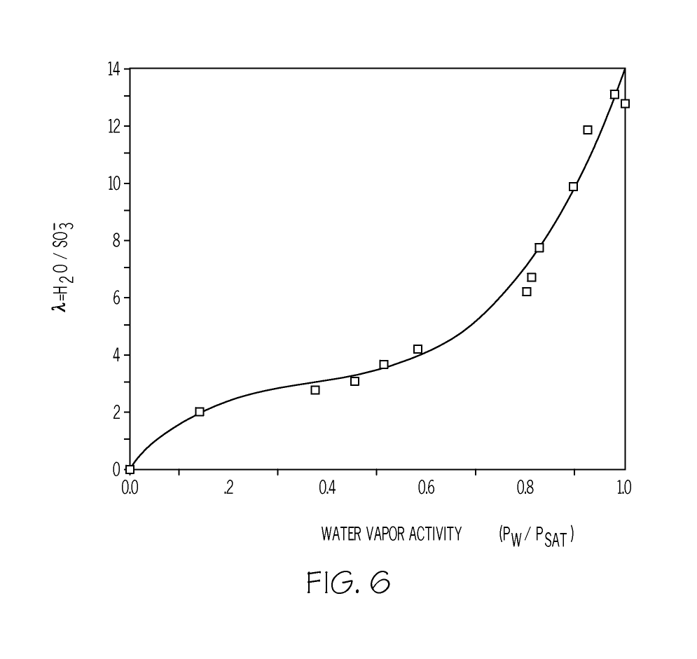

From the HFR measurement, stack temperature and stack membrane thickness, the average value of MEA hydration λ can be estimated. The correlation between MEA hydration λ and stack cathode average RH are well-known, as evidenced by the graph in FIG. 6, where for example, inputs of operating conditions, such as cathode inlet and outlet pressure, coolant inlet and outlet temperature cathode air flow and stack current permit performing a water specie balance around stack which would in turn yield the stack cathode inlet and outlet RHs and the amount of water in the cathode inlet stream. Subtracting the ambient water flowrate in the cathode air flow (estimated from an ambient RH sensor measurement) from the amount of water flow in the cathode inlet stream would yield the WVT in-situ water transfer rate; the details of such calculations can be found in the aforementioned U.S. application Ser. No. 12/622,212. This WVT in-situ water transfer rate then can be used in the reverse WVT model to estimate K_{deg,t} at any given vehicle time using the mechanism depicted in FIG. 4. With the estimated K_{deg,t} from the reverse WVT model, along with the expected maximum power operating conditions, the forward WVT is utilized to project the WTR at maximum power at the given vehicle life time WTR^{max}^{_{—}}^{pwr}_{tlife} using the equations shown in original claims 5 through 10. From this, the degree of WVT degradation is determined by comparing WTR^{max}^{_{—}}^{pwr}_{tlife} and the predicted BOL water transfer rate WTR^{max}^{_{—}}^{pwr}_{BOL}.

It is noted that terms like “generally”, “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the terms “substantially” and “about” are utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of in-situ water vapor transport device degradation detection, the method comprising:
providing in-situ a water vapor transport device water transfer rate;
estimating a reduced water vapor transport device effectiveness at any given vehicle time using the in-situ water vapor transport device water transfer rate in conjunction with operating conditions input data corresponding to the given vehicle time;
estimating a water transfer rate at maximum power using the reduced water vapor transport device effectiveness in conjunction with expected operating condition input data corresponding to the maximum power;
estimating a beginning of life water transfer rate at maximum power using known beginning of life design parameters of the water vapor transport device; and
comparing the estimated water transfer rate at maximum power with the estimated beginning of life water transfer rate at maximum power.

2. The method of claim 1, wherein providing the in-situ water vapor transport device water transport rate is through a relative humidity sensor.

3. The method of claim 1, wherein providing the in-situ water vapor transport device water transport rate is through a stack high frequency resistance measurement.

4. The method of claim 1, wherein said estimating a reduced water vapor transport device effectiveness at any given vehicle time comprises:
using estimated reduced mass transfer coefficients from the in-situ water vapor transport device water transfer rate;
determining a capacity ratio that identifies the relationship between wet and dry streams flowing through the water vapor transfer device;
determining the number of mass transfer units flowing through the water vapor transfer device;
estimating a mass transfer effectiveness value using the capacity ratio and the number of mass transfer units for the water vapor transfer device; and
determining the amount of water transferred from the wet stream to the dry stream in the water vapor transfer device using the mass transfer effectiveness value, mass flow rates on a dry basis of the dry stream and the wet stream, and mass flow rates of water in the dry inlet stream and the wet inlet stream.

5. The method of claim 4, wherein the capacity ratio is determined using the equation:
$$CR = \frac{Min ( {M}_{air , dry} , {M}_{wet , air} )}{Max ( {M}_{air , dry} , {M}_{wet , air} )}$$
where M_{air,dry} is a mass flow rate on a dry basis flowing through a dry side of the water vapor transfer device and M_{air,wet} is the mass flow rate on a dry basis flowing through a wet side of the water vapor transfer device.

6. The method of claim 4, wherein determining the number of mass transfer units includes using the equation:
$$NTU = \frac{UA}{min ( {M}_{air , dry} , {M}_{air , wet} )}$$
where NTU is the number of mass transfer units, U is a mass transfer coefficient, A is a surface area in the water vapor transfer device available to transfer water vapor, M_{air,dry} is a mass flow rate on a dry basis through a dry side of the water vapor transfer device and M_{wet,air} is a mass flow rate on a dry basis through a wet side of the water vapor transfer device.

7. The method of claim 6, wherein the product UA is determined by the equation:
$$UA = ( {a}_{1} \times {M}_{air , wet} / A + {a}_{2} \times {M}_{air , dry} / A + b \times {RH}_{wetin} + c ) \times exp ( - \frac{{E}_{a}}{R \times {T}_{ave , in}} ) \times \frac{A}{{A}_{bass}} \times {K}_{deg} ¶$$
where RH_{wetin} is the relative humidity of a wet inlet stream to the water vapor transfer device, T_{ave,in} is an average temperature of the wet and dry streams flowing through the water vapor transfer device, Eₐ is activation energy, A is the membrane area, a, b and c are correlation coefficients, K_{deg} is the degradation factor of water vapor transport membrane material and A_{base} is the membrane area of the humidifier design from which the correlation parameters were obtained.

8. The method of claim 4, wherein estimating the mass transfer effectiveness of the water vapor transfer device includes using a lookup table for heat transfer effectiveness, or a crossflow, unmixed fluid equation:
$$ɛ = 1 - exp [ ( \frac{1}{{c}^{*}} ) \times {( NTU )}^{0.22} \times \{ exp [ - {C}^{*} R \times {( NTU )}^{0.78} ] - 1 \} ]$$
where ε is the effectiveness value, CR is the capacity ratio and NTU is the number of mass transfer units.

9. The method of claim 8, wherein the effectiveness value ε is defined as:
$$ɛ = \frac{{M}_{air , dry} \times ( {Y}_{dryout} - {Y}_{dryin} )}{min ( {M}_{air , dry} , {M}_{air , wet} ) \times ( {Y}_{wetin} - {Y}_{dryin} )}$$
where Y_{dryin} is determined by
$${Y}_{dryin} = \frac{{M}_{h2o , dryin}}{{M}_{air , dry}} ,$$
Y_{dryout} is determined by
$${Y}_{dryout} = \frac{{M}_{h2o , dryout}}{{M}_{air , dry}} ,$$
Y_{wetin} is determined by
$${Y}_{wetin} = \frac{{M}_{h2o , wetin}}{{M}_{air , wet}} ,$$
M_{air,dry} is the mass flow rate on a dry basis of the dry stream, M_{air,wet} is the mass flow rate on a dry basis of the wet stream, M_{h2o,dryin} is the mass flow rate of water entering the water vapor transfer device on the dry stream, M_{h2o,dryout} is the mass flow rate of water exiting the water vapor transfer device on the dry stream, M_{h2o,wetin} is the mass flow rate of water entering the water vapor transfer device on the wet stream and Y is the mass flow of water per mass flow of dry air ((gm water/sec)/(gm air/sec)).

10. The method of claim 9, wherein determining the amount of water transferred includes using the equation:
$$\begin{matrix}{N}_{w} = {M}_{air , dry} \times ( {Y}_{dryout} - {Y}_{dryin} ) \\ = ɛ \times min ( {M}_{air , dry} , {M}_{air , wet} ) \times ( {Y}_{wetin} - {Y}_{dryin} ) \\ = ɛ \times min ( {M}_{air , dry} , {M}_{air , wet} ) \times ( \frac{{M}_{h2o , wetin}}{{M}_{air , wet}} - \frac{{M}_{h2o , dryin}}{{M}_{air , dry}} ) .\end{matrix}$$

11. The method of claim 1, wherein the estimating a reduced water vapor transport device effectiveness at any given vehicle time corresponds to a reverse effectiveness model based on historical vehicular data, and wherein estimating a water transfer rate corresponds to a forward water transfer rate model under expected maximum power conditions.

12. The method of claim 11, further comprising:
taking an output from the forward water transfer rate model utilizing the estimated reduced water vapor transport device effectiveness at any given vehicle time;
inputting it into a fuel cell stack control; and
using the control to improve at least one of stack performance and durability.

13. The method of claim 11, further comprising:
taking an output from the forward water transfer rate model utilizing the estimated reduced water vapor transport device effectiveness at any given vehicle time;
inputting it into a fuel cell stack control;
conducting an ohmic loss prediction;
improving stack power prediction for a maximum power condition; and
using at least one of the ohmic loss prediction and stack power prediction to improve service time prediction of the fuel cell stack.

14. The method of claim 11, further comprising:
utilizing, by at least one processor, a controller to receive at least one input corresponding to the provided in-situ water vapor transport device water transfer rate; and
operating the controller such that results generated by the reverse model and the forward model are compared to the beginning of life water transfer rate at maximum power conditions to determine a loss in water vapor transfer rate within the water vapor transport device.

15. The method of claim 1, wherein the beginning of life water vapor transport device design parameters comprise at least one of mass transfer coefficients and membrane area.

16. A method of servicing a water vapor transport device used in a fuel cell system, the method comprising:
providing in-situ a water vapor transport device water transfer rate;
estimating a reduced water vapor transport device effectiveness at any given vehicle time using the in-situ water vapor transport device water transfer rate in conjunction with corresponding operating conditions input data;
estimating a water transfer rate at maximum power at any given vehicle time using the reduced water vapor transport device effectiveness in conjunction with expected operating condition input data at maximum power; and
estimating a beginning of life water transfer rate at maximum power using known beginning of life water vapor transport device design parameters comprising mass transfer coefficients and membrane area;
comparing the estimated water transfer rate at maximum power at any given vehicle time with the estimated beginning of life water transfer rate at maximum power and estimate the difference; and
servicing the water vapor transport device when the degree of water vapor transport device on-line degradation at maximum power exceeds a percentage of the beginning of life water transfer rate at maximum power by a predetermined value.

17. The method of claim 16, wherein said estimating a reduced water vapor transport device effectiveness corresponds to a reverse effectiveness model based on historical vehicular data, and wherein estimating a water transfer rate for a second time corresponds to a forward water transfer rate model based on balance of life under expected maximum power conditions.

18. A water vapor transport device for use in a fuel cell system, the device comprising:
at least dry side flowpath;
at least one wet side flowpath;
a membrane disposed in cooperation with the at least one dry side flowpath and the at least one wet side flowpath such that upon passage of respective relatively dry and relatively wet fuel cell reactant therethrough, an exchange in humidity occurs between them;
at least one sensor configured to measure water transfer rate information corresponding to the device; and
a controller cooperative with the at least one sensor, the controller configured to:
estimate a reduced water vapor transport effectiveness for the device;
estimate a plurality of water transfer rate for the device; and
compare the estimated plurality of water transfer rates to determine a loss in operability of the device.

19. The device of claim 18, wherein the controller is further configured to:
receive input in the form of water transfer rate information from the at least one sensor into a backward-looking model;
receive information pertaining to backward-looking vehicular operating condition data into the backward-looking model;
output the estimated reduced water vapor transport effectiveness for the device to a forward-looking model used to estimate the water transfer rate for the device;
receive information pertaining to beginning of life water vapor transport device design parameters comprising mass transfer coefficient and membrane area, and expected maximum power operating conditions to place into the forward-looking model to estimate the beginning of life water transfer rate at maximum power; and
estimate the water transfer rate loss in the device by comparing the estimated water transfer rate at maximum power at any given vehicle time using the reduced water vapor transport device effectiveness and the estimated beginning of life water transfer rate at maximum power to receive a plurality of effectiveness signals into the forward-looking model such that the estimated water transfer rate loss in the device is based on differences in the forward-looking and backward-looking effectiveness estimations.

20. The device of claim 18, wherein the estimated water transfer rate for the device corresponds to expected vehicular maximum power conditions.
